(19) United States
(12) Patent Application Publication
(10) Pub. No.: US 2022/0166255 A1
(43) Pub. Date: May 26, 2022

(54) Control Method and Related Wireless Power Transmitter Capable of Acquiring Quality Factor of Resonant Circuit

(71) Applicant: Weltrend Semiconductor Inc., Hsinch (TW)

(72) Inventors: Chia Pao WU, Hsinchu (TW); Cheng Liang LIN, Hsinchu (TW)

(21) Appl. No.: 17/202,754

(22) Filed: Mar. 16, 2021

(30) Foreign Application Priority Data
Nov. 25, 2020 (TW) 109141223

(51) Int. Cl. H02J 50/12

(52) U.S. Cl. CPC H02J 50/12

(57) ABSTRACT

A control method is disclosed for acquiring a quality factor of a resonant circuit. The resonant circuit has an input node and a detection node. A first DC bias is provided to the input node for a settle time, so that the resonant circuit settles substantially in a first predetermined static state. A second bias different from the first DC bias is provided to the input node, so that the resonant circuit oscillate to settle into a second predetermined static state. A count is acquired, representing how many times a detection signal at the detection node goes across a predetermined value. The quality factor of the resonant circuit is acquired in response to the count.

### CROSS-REFERENCE TO RELATED APPLICATION

This application claims priority to and the benefit of Taiwan Application Series Number 109141223 filed on Nov. 25, 2020, which is incorporated by reference in its entirety.

### BACKGROUND

The present disclosure relates generally to a wireless power transmission system, and more particularly, to apparatuses and methods that determine whether to wirelessly transmit power based on a quality factor of the wireless power transmission system.

Wireless power transmission is convenient and popular nowadays because it needs no physical wire to supply power to power receivers such as mobile phones. A wireless power transmitter in a wireless power transmission system excites a resonant circuit, which resonates to radiate electromagnetic wave that a wireless power receiver could receive through the air and convert into a DC power source to supply power.

An object might happen somewhere between the wireless power transmitter and the wireless power receiver, and, if it is made of electrically conductive material like metal, this object might absorb some power that the receiver should receive otherwise. A metallic object therebetween not only adversely impacts the conversion efficiency of the power transmission, but also generates heat that could cause fire in some circumstances. Therefore, object detection is important for wireless power transmission. Wireless power consortium, WPC, suggests to detect a quality factor of the power transmitter to determine whether there is an object affecting the power transmission.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 demonstrates wireless power transmission system;

FIG. 2 shows a control method in use of wireless power transmitter TR;

FIG. 3 demonstrates input signal V_{DR}, voltage drop V_{CT}, representative V_{DDR} and count CN; and

FIG. 4 demonstrates Q-factor detection time T_{Q} follows every normal power supply time T_{PT}.

### DETAILED DESCRIPTION

An embodiment of the invention in the beginning settles an LC resonant circuit of a wireless power transmitter in a first static state. Secondly, an input voltage at an input node of the LC resonant circuit is abruptly changed by a certain value, so the LC resonant circuit exits the first static state and starts oscillation, which is damped over time and will settle into a second static state different from the first one. On the way that the oscillation is damped to settle into the second static state, it is counted how many times a detection signal at a detection node of the LC resonant circuit goes across a predetermined value. The count as generated is used for calculating a quality factor, a parameter determining whether to stop providing power to a wireless power receiver because there might be an unwelcome metallic object that deteriorates the quality factor.

When the input voltage is abruptly changed, the LC resonant circuit no more settles into the first static state, and the change to the input voltage sets up initial conditions, starting from which the LC resonant circuit starts oscillating. The initial conditions include the initial amplitude of the detection signal. The change to the input voltage also determines the second static state that the LC resonant circuit is going to settle in. The count roughly represents the duration during which the amplitude of the oscillation is consumed or dampened from the initial amplitude to the predetermined value, and this duration is in association with the quality factor.

For example, if the count is low, meaning the detection signal rapidly fails to go across the predetermined value, it implies that the damping rate is high and the quality factor is little or poor, probably an object somewhere nearby absorbing the power transmitted from the wireless power transmitter. Therefore, the wireless power transmitter stops wireless power transmission in response to the acquired quality factor.

In the opposite, if the count is high, implying that the oscillation can last for a long time, that the energy stored by the oscillation is not seriously consumed, and that high quality factor is expected, supposedly there is no unwelcome object nearby and the wireless power transmitter can freely emit its RF power.

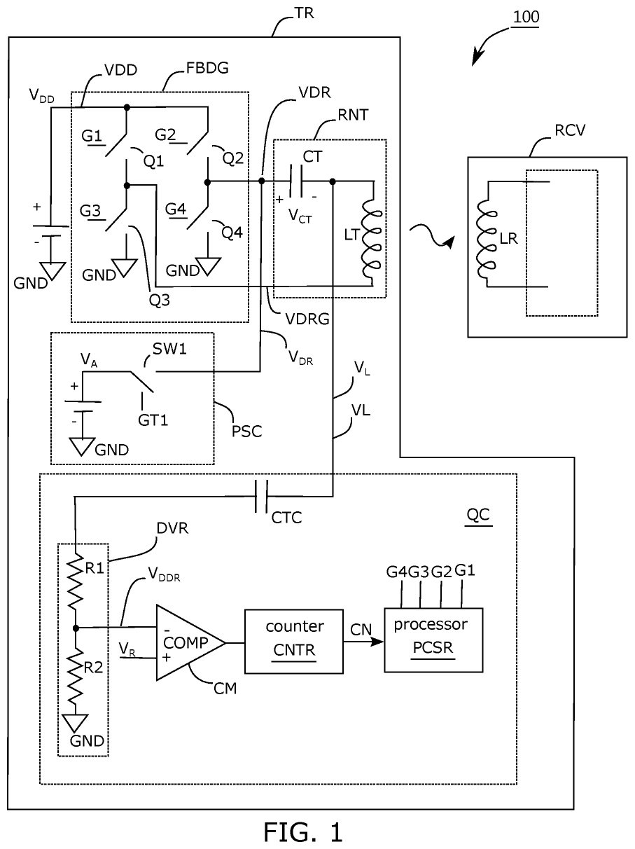

FIG. 1 demonstrates wireless power transmission system 100 including wireless power transmitter TR and wireless power receiver RCV. Wireless power transmitter TR is capable of energizing transmit coil LT, through which power is transmitted to receiver coil LR. The induced voltage on receiver coil can be rectified to provide a DC power source that internal circuits of wireless power receiver RCV need for operation.

Wireless power transmitter TR in FIG. 1 includes resonant circuit RNT, inverter FBDG, DC static-state presetting circuit PSC, and Q-factor detector QC.

Resonant circuit RNT includes, among others, capacitor CT and transmit coil LT connected in series. For example, it might further include some other capacitors or inductors to fine tune the resonant frequency of resonant circuit RNT. Shown in FIG. 1, the two opposite terminals of capacitor CT are input node VDR and detection node VL, at which are input signal V_{DR} and detection signal V_{L} respectively.

Inverter FBDG is capable of exciting resonant circuit RNT, which oscillates to radiate electromagnetic wave from transmit coil LT. As shown in FIG. 1, inverter FBDG is in the form of a full-bridge inverter with high-side switches Q1 and Q2, and low-side switches Q3 and Q4. High-side switch Q1 and low-side switch Q3 are connected in series between power line VDD and ground line GND, and the joint therebetween is connected to input node VDRG of resonant circuit RNT. Similarly, high-side switch Q2 and low-side switch Q4 are connected in series between power line VDD and ground line GND, and the joint therebetween is connected to input node VDR of resonant circuit RNT. Power line VDD and ground line GND are two power lines, and the voltage of ground line GND is deemed to be 0V, as a reference voltage for all other voltages inside wireless power transmitter TR. Providing proper signals at gate electrodes G1, G2, G3, and G4 could be able to oscillate resonant circuit RNT at an expected frequency to supply power to wireless power receiver RCV. When energizing resonant circuit RNT to supply power to wireless power receiver RCV, the voltage levels at gate electrodes G1, G2, G3, and G4 change over time, the signals at gate electrodes G1 and G3 are substantially complimentary to each other, and so are the signals at gate electrodes G2 and G4.

According to other embodiments of the invention, the driver that drives and excites resonant circuit RNT might not be a full-bridge inverter. In an embodiment of the invention, the driver is a half-bridge inverter with high-side switch Q2 and low-side switch Q4 shown in FIG. 1, but without high-side switch Q1 and low-side switch Q3, while input node VDRG is electrically connected to ground line GND.

DC static-state presetting circuit PSC has a setting switch SW1 and a voltage source providing DC (direct current) bias V_{A}. A switch is turned ON if it provides a short circuit between its two terminals, and it is turned OFF when the short circuit becomes an open circuit. These two terminals are for example the drain and source electrodes of a MOS transistor. When setting switch SW1 is turned ON, low-side switch Q3 ON, and high-side switches Q1 and Q2 and low-side switch Q4 OFF, DC static-state presetting circuit PSC sets input node VDR at DC bias V_{A}. If all these switches remain unchanged for a very long time, resonant circuit RNT will eventually settle into static state STDY₀. A static state of resonant circuit RNT means all the voltages or the currents in resonant circuit RNT are constant, or unchanged over time. Resonant circuit RNT equivalently settles into a static state if all the voltages and currents therein hardly change. For example, when input signal V_{DR} at input node VDR is supplied with DC bias V_{A} and input node VDRG is shorted to ground line GND, resonant circuit RNT will eventually settle into static state STDY₀ where detection signal V_{L} at detection node VL is 0V, the current flowing through transmit coil LT OA, and voltage drop V_{CT} across capacitor CT DC bias V_{A}.

Q-factor detector QC, as shown in FIG. 1, has capacitor CTC, voltage divider DVR, comparator CM, counter CNTR and processor PCSR. Q-factor detector QC in FIG. 1 is only an example and is not for limiting the scope of the invention, and an embodiment of the invention might have a Q-factor detector different from the one in FIG. 1.

Capacitor CTC alternating-current (AC) couples detection signal V_{L} to voltage divider DVR, which in response provides representative V_{DDR} in proportion to detection signal V_{L}. Comparator CM compares representative V_{DDR} with reference signal V_{R}. In one embodiment of the invention, an amplifier (not shown) is connected between comparator CM and voltage divider DVR to amplify the signal at the joint in voltage divider DVR and to accordingly provide representative V_{DDR} to comparator CM. The combination of voltage divider DVR and comparator CM is configured to detect whether detection signal V_{L} goes across a predetermined value corresponding to reference signal V_{R}. Counter CNTR counts in response to the output of comparator CM to provide count CN, acquiring how many times detection signal V_{L} goes across the predetermined value. FIG. 1 demonstrates that count CN is the number of times when detection signal V_{L} increases to exceed the predetermined value. Count CN in other embodiments of the invention might be the number of times when detection signal V_{L} drops to be less than the predetermined value.

Processor PCSR could be a microprocessor or a digital signal processor that controls invertor FBDG, DC static-state presetting circuit PSC, and counter CNTR. Processor PCSR is configured to determine whether to supply power to wireless power receiver RCV in response to count CN. Based upon count CN and a predetermined equation that will be introduced later, processor PCSR calculates quality factor Q. If quality factor Q is high enough, exceeding a predetermined criterion, processor PCSR turns OFF setting switch SW1 to disable DC static-state presetting circuit PSC, and provides suitable signals to inverter FBDG to excite resonant circuit RNT, which according radiates to supply power to wireless power receiver RCV. In case that quality factor Q is poorly low, below the predetermined criterion for example, processor PCSR constantly keeps high-side switches Q1 and Q2 and low-side switches Q3 and Q4 turned off, not providing power to resonant circuit RNT or wireless power receiver RCV.

When disabling DC static-state presetting circuit PSC, processor PCSR can control inverter FBDG to provide to input node VDR another DC bias different from DC bias V_{A}. For example, during calculation time T_{MSR} that will be detailed later, processor PCSR provides suitable signals to gate electrodes G1, G2, G3 and G4, constantly turning OFF high-side switch Q1 and low-side switch Q4 and turning ON high-side switch Q2 and low-side switch Q3. Therefore, during calculation time T_{MSR}, the DC bias provided at input node VDR is voltage V_{DD}, and input node VDRG is virtually ground. In the beginning of calculation time T_{MSR}, the sudden voltage change at input node VDR makes resonant circuit exit static state STDY₀ and excites oscillations of resonant circuit RNT. Resonant circuit RNT, however, will eventually settles into another static state STDY_{NEW} where detection signal V_{L} at detection node VL is 0V, the current flowing through transmit coil LT OA and voltage drop V_{CT} across capacitor CT voltage V_{DD}.

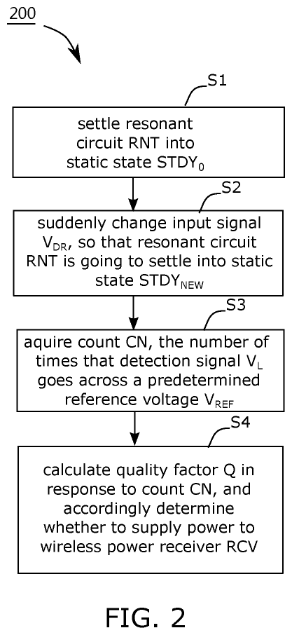

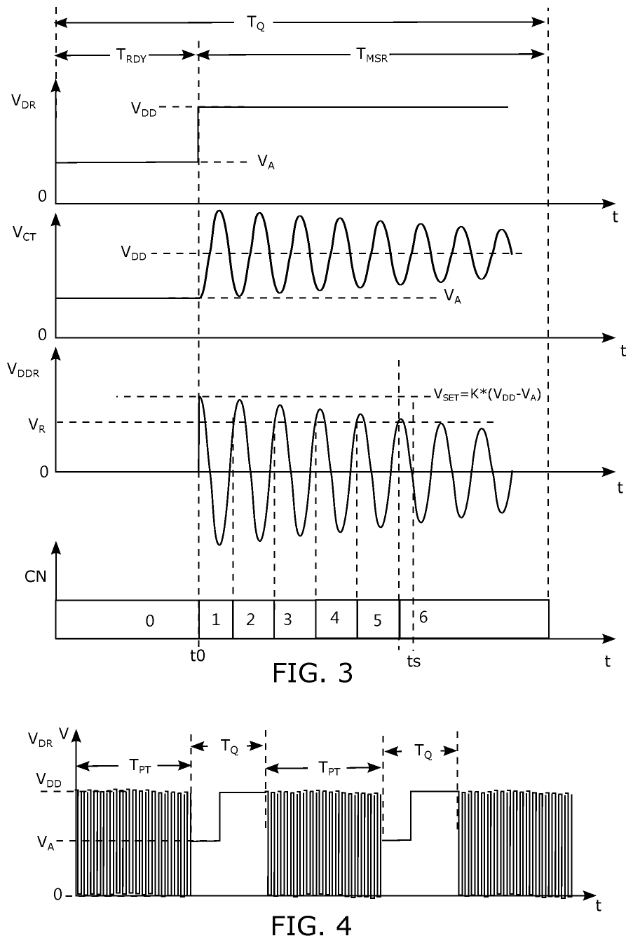

FIG. 2 shows control method 200 in use of wireless power transmitter TR, and FIG. 3 demonstrates input signal V_{DR}, voltage drop V_{CT}, representative V_{DDR} and count CN when wireless power transmitter TR performs control method 200. As previously taught, representative V_{DDR} could represent detection signal V_{L}. For example, V_{DDR}=K*V_{L} in FIG. 3 where K is a constant determined by voltage divider DVR. The correlation between representative V_{DDR} and detection signal V_{L} depends on the circuit configuration. For some embodiments of the invention, K must involve the gain of an amplifier which is added somewhere in the signal path, to amplify representative V_{DDR} before sending it to comparator CM.

Please refer to FIGS. 2 and 3. In FIG. 2, step S1 substantially settles resonant circuit RNT into static state STDY₀. As shown in FIG. 3, Q-factor detection time T_{Q} includes, but is not limited to include, settle time T_{RDY} and calculation time T_{MSR}, where calculation follows right after settle time T_{RDY}. During settle time T_{RDY}, setting switch SW1 is ON, high-side switches Q1 and Q2 and low-side switch Q4 are OFF, low-side switch Q3 is ON, and input signal V_{DR} at input node VDR is DC bias V_{A}, as shown in FIG. 3. Only if settle time T_{RDY} is long enough, resonant circuit RNT settles into static state STDY₀. In a static state, all variables in resonant circuit RNT are substantially constant with respect to time. Static state STDY₀ includes, but is not limited to, conditions that voltage drop V_{CT} is DC bias V_{A} and representative V_{DDR} 0V, as shown in FIG. 3.

Step S2 follows step 1 in FIG. 2, suddenly changing input signal V_{DR} to excite resonant circuit RNT to settle into static state STDY_{NEW}. At moment t0, the end of settle time T_{RDY} in FIG. 3 and the beginning of calculation time T_{MSR}, processor PCSR turns OFF setting switch SW1, turns ON high-side switch Q2, while other switches remain unchanged. Therefore, input signal V_{DR} is suddenly changed from DC bias V_{A} into voltage V_{DD}, the voltage at power line VDD, as shown by the waveform of input signal V_{DR} in FIG. 3. Since the voltage across a capacitor cannot change abruptly, detection signal V_{L} at moment t0 gains the same voltage change to input signal V_{DR}, which is equal to voltage V_{DD} minus DC bias V_{A}. Accordingly, representative V_{DDR} changes from 0V to predetermined voltage V_{SET}, which is equal to K*(V_{DD}−V_{A}) as shown in FIG. 3.

During calculation time T_{MSR}, conditions of the switches inside DC static-state presetting circuit PSC and inverter FBDG remain unchanged, so input signal V_{DR} is always at voltage V_{DD}. The sudden change to input signal V_{DR} at moment t0 sets an initial condition to resonant circuit RNT and replaces static state STDY₀ with static state STDY_{NEW} that resonant circuit RNT will settle in. This initial condition makes representative V_{DDR} voltage V_{SET} at moment to. Static state STDY_{NEW} includes, but is not limited to, conditions that voltage drop V_{CT} is voltage V_{DD} and representative V_{DDR} 0V. As calculation time T_{MSR} goes by, resonant circuit RNT oscillates but the amplitude of the oscillation shrinks and the stored electromagnetic energy releases over time with respect to the quality factor Q that resonant circuit RNT currently has. As shown in FIG. 3, both voltage drop V_{CT} and representative V_{DDR} oscillate and their oscillations dampen during calculation time T_{MSR}. If calculation time T_{MSR} is infinite, voltage drop V_{CT} will settle in voltage V_{DD} and representative V_{DDR} in 0V.

Step S3 in FIG. 2 counts how many times detection signal V_{L} goes across reference voltage V_{REF} and accordingly provides count CN. For example, it is shown in FIG. 3 that representative V_{DDR} ramps up to cross reference signal V_{R} 6 times before moment ts, and that representative V_{DDR} no longer reaches reference signal V_{R} after moment is during calculation time T_{MSR}, where reference signal V_{R} corresponds to reference voltage V_{REF}. Therefore, at the end of calculation time T_{MSR}, count CN is 6 because detection signal V_{L} has increased to cross reference voltage V_{REF} 6 times during calculation time T_{MSR}.

Step S4 in FIG. 2 calculates quality factor Q to determine whether to energize resonant circuit RNT and to supply power to wireless power receiver RCV. The larger count CN, the less dampening, the higher quality factor Q. Therefore, processor PSCR derives quality factor Q based on count CN acquired during calculation time T_{MSR} and equation I as follows.

Q˜π*(CN−0.5)/[ln(V_{SET})−ln(V_{R})]=2KQ*(CN−0.5), (I)

where KQ is a constant equal to π/[ln(V_{SET})−ln(V_{R})] and both voltage V_{SET} and reference voltage V_{R} are known and predetermined.

At or after the end of calculation time T_{MSR}, processor PSCR obtains quality factor Q based on count CN and equation I. If quality factor Q is poorly low, or below a predetermined value, it may imply the existence of an unwelcome object that reduces quality factor Q, so processor PSCR controls inverter FBDG to stop both energizing resonant circuit RNT and supplying power to wireless power receiver RCV.

FIG. 4 demonstrates that Q-factor detection time T_{Q} follows every normal power supply time T_{PT}. During normal power supply time T_{PT}, which has a fixed duration of time according to some embodiments of the invention, processor PCSR provides suitable signals to gate electrodes G1, G2, G3 and G4, so inverter FBDG excites resonant circuit RNT to transmit power to wireless power receiver RCV. Input signal V_{DR} at input node VDR jumps back and forth between voltage V_{DD} and 0V during normal power supply time T_{PT} as shown in FIG. 4. During Q-factor detection time T_{Q} however, input signal V_{DR} is first held at DC bias V_{A} for a period of settle time T_{RDY}, and then abruptly changed and held to be voltage V_{DD} for a period of calculation time T_{MSR}. At the end of Q-factor detection time T_{Q}, processor PCSR checks whether quality factor Q is high enough based on the acquired count. Only if quality factor Q is high enough, processor PCSR controls inverter FBDG to enter a next normal power supply time T_{PT}.

Wireless power transmitter TR taught in FIGS. 1-4 employs simple analog circuits, based on which processor PCSR can acquire quality factor Q rapidly.

DC bias V_{A} could be any fixed voltage, and is not limited to be a fixed voltage between voltage V_{DD} and 0V as shown in FIG. 3. Static states STDY₀ and STDY_{NEW} need be different but are not limited to the ones disclosed by FIG. 3 and related teachings. Exiting static state STDY₀ to settle into static state STDY_{NEW} causes the oscillation of detection signal V_{L} in resonant circuit RNT, and the dampening rate of the oscillation corresponds with quality factor Q.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless power transmitter, comprising:
a resonant circuit with an input node and a detection node;
a DC static-state presetting circuit for providing a DC bias to the input node to substantially settle the resonant circuit into a first predetermined static state; and
a Q-factor detector, configured to perform the following steps comprising:
exciting oscillations of the resonant circuit, so that the resonant circuit exits the first predetermined static state and oscillates to settle into a second predetermined static state different from the first predetermined static state;
acquiring a count that represents the times a detection signal at the detection node goes across a predetermined value; and
determining in response to the count whether to supply power to a wireless power receiver.

2. The wireless power transmitter of claim 1, further comprising:
an inverter for exciting the resonant circuit to supply power to the wireless power receiver, wherein the inverter has at least a switch connected between the input node and a power line;
wherein when the Q-factor detector disables the DC static-state setting circuit, the switch is turned on so the resonant circuit oscillates to settle into the second predetermined static state.

3. The wireless power transmitter of claim 2, wherein the DC static-state presetting circuit includes a setting switch capable of setting the input node at a predetermined voltage different from the voltage at the power line.

4. The wireless power transmitter of claim 1, wherein the Q-factor detector comprises:
a voltage divider electrically coupled to the detection node to provide a representative;
a comparator comparing the representative with a reference signal; and
a counter to generate the count in response to an output of the comparator.

5. The wireless power transmitter of claim 1, wherein the Q-factor detector acquires a quality factor in response to the count, and stops supplying power to the wireless power receiver if the quality factor is less than a predetermined reference value.

6. The wireless power transmitter of claim 1, wherein the Q-factor detector disables the DC static-state presetting circuit and changes the DC bias at the input node to excite the oscillations of the resonant circuit.

7. The wireless power transmitter of claim 1, wherein Q-factor detector disables the DC static-state presetting circuit and sets an initial condition to the resonant circuit, and the count is acquired during the time when the resonant circuit oscillates with the initial condition to settle into the second predetermined static state.

8. A control method in use of a wireless power transmitter with a resonant circuit, wherein the resonant circuit provides a detection node with a detection signal, the control method comprising:
substantially settling the resonant circuit into a first predetermined static state;
exciting oscillations of the resonant circuit so that the resonant circuit exits the first predetermined static state and oscillates to settle into a second predetermined static state different from the first predetermined static state;
acquiring a count that represents the times the detection signal goes across a predetermined value; and
determining in response to the count whether to supply power to a wireless power receiver.

9. The control method of claim 6, wherein the resonant circuit has an input node, and the control method comprises:
providing a first DC bias to the input node so that the resonant circuit settles substantially into the first predetermined static state; and
providing a second DC bias different from the first DC bias to the input node so that the resonant circuit oscillates to settle into the second predetermined static state.

10. The control method of claim 9, wherein the second DC bias is a voltage of a power line, and the wireless power transmitter includes an inverter with a switch electrically connected between the power line and the input node.

11. The control method of claim 9, comprising:
providing the first DC bias to the input node for a settle time;
providing the second DC bias to the input node right after the settle time; and
acquiring the count during a calculation time right after the settle time.

12. The control method of claim 8, comprising:
acquiring a quality factor in response to the count and a predetermined equation; and
determining in response to the quality factor whether to supply power to the wireless power receiver.

13. The control method in use of a wireless power transmitter with a resonant circuit, wherein the resonant circuit provides an input node and a detection node with a detection signal, the control method comprising:
providing a first DC bias to the input node for a settle time, so that the resonant circuit settles substantially in a first predetermined static state;
providing a second DC bias to the input node right after the settle time, wherein the second DC bias is different to the first DC bias;
acquiring a count that represents how many times a detection signal at the detection node goes across a predetermined value; and
acquiring a quality factor of the resonant circuit in response to the count.

14. The control method of claim 13, comprising:
providing the second DC bias to the input node for a calculation time right after the settle time; and
acquiring the count during the calculation time.

15. The control method of claim 13, comprising:
providing the second DC bias to the input node right after the settle time, so that the resonant circuit oscillates to settle into a second predetermined static state different from the first predetermined static state.
